(19) United States
(12) Patent Application Publication
(10) Pub. No.: US 2026/0056161 A1
(43) Pub. Date: Feb. 26, 2026

(54) THIN LAYER TYPE ELECTROCHEMICAL SYSTEM INCLUDING SALT BRIDGE AND ELECTROCHEMICAL ANALYSIS METHOD USING THE SAME

(71) Applicant: SEOUL NATIONAL UNIVERSITY R&DB FOUNDATION, Seoul (KR)

(72) Inventors: Taek Dong CHUNG, Gwacheon-si (KR); Ji Yong KIM, Seoul (KR)

(21) Appl. No.: 18/684,725

(22) PCT Filed: Feb. 11, 2022
(86) PCT No.: PCT/KR2022/002069

§ 371 Date: Sep. 19, 2025

(30) Foreign Application Priority Data
Aug. 30, 2021 (KR) 10-2021-0114958

(51) Int. Cl. G01N 27/401; G01N 27/48

(52) U.S. Cl. CPC G01N 27/401; G01N 27/48

(57) ABSTRACT

The present disclosure relates to a thin layer type electrochemical system including a salt bridge and an electrochemical analysis method using the same and, more particularly, to a thin layer type electrochemical system including a salt bridge and an electrochemical analysis method using the same, which implement the chamber part accommodating the analytical solution of the thin layer type electrochemical system including a salt bridge, such that it is thinner than the diffusion layer; use polyelectrolyte gel as a salt bridge to limit lateral diffusion of reactants; use a specific polyelectrolyte gel; and use a transparent working electrode, thereby measuring the peaks of several consecutive reactions in voltammetry with high resolution, enabling analysis of organic solvents, and allowing electrochemical and spectroscopic measurements to be performed simultaneously.

### CROSS REFERENCE TO RELATED APPLICATIONS

This application claims the benefit of priority to Korean Patent Application No. 10-2021-0114958, filed with the Korean Intellectual Property Office on Aug. 30, 2021, the contents of which are incorporated herein by reference in its entirety.

### TECHNICAL FIELD

The present disclosure relates to a thin layer type electrochemical system including a salt bridge and an electrochemical analysis method using the same and, more particularly, to a thin layer type electrochemical system including a salt bridge and an electrochemical analysis method using the same, which implement the chamber part accommodating the analytical solution of the thin layer type electrochemical system including a salt bridge, such that it is thinner than the diffusion layer; use polyelectrolyte gel as a salt bridge to limit lateral diffusion of reactants; use a specific polyelectrolyte gel; and use a transparent working electrode, thereby measuring the peaks of several consecutive reactions in voltammetry with high resolution, enabling analysis of organic solvents, and allowing electrochemical and spectroscopic measurements to be performed simultaneously.

### BACKGROUND ART

As electrochemistry is widely used in various fields such as energy conversion through electrocatalysis, electroorganic synthesis, and electrochemical detection of neurotransmitters, the importance of understanding the mechanisms of electrochemical reactions is increasing. Among them, especially the electro-organic field has many advantages, such as relatively easy electron transfer through the adjustment of the electrode potential, eliminating the generation of by-products in the existing method of molecule-to-molecule reaction, and enabling the mild (ambient) conditions to be applicable instead of high-temperature and high-pressure reaction conditions.

In this field, the reaction mechanism must be understood to adjust reactivity and selectivity. Up to now, analysis through electrochemical methods has mainly been conducted using cyclic voltammetry, which provides rough information about the voltage, reaction rate, and the like at which a reaction occurs, but has limitations in predicting the products produced through the reaction.

Another approach is to obtain the number of electrons transferred n, a parameter that refers to the number of electrons transferred between an electrode and a molecule in an electrochemical reaction. This parameter provides more direct information about the results of electron transfer, produced intermediates, and products. Conventional techniques for obtaining the number of electrons transferred n, such as the rotating electrode technique or time-to-current method have such problems that they cannot obtain the number of electrons transferred n alone, and that it is difficult to apply them to a complex multi-electron transfer reaction or under organic solvent conditions. Another method, bulk electrolysis, has such problems that it takes a long period of time to react all of a large volume of solution, and that side reactions may occur in this process, causing inaccurate results.

In order to overcome the drawbacks of the conventional technologies as described above, the present disclosure will present an electrochemical system and an electrochemical analysis method using the same that can quickly and accurately derive the number of electrons transferred n without being subject to various limitations.

With regard to this, thin layer electrochemistry can be utilized, and, however, the existing thin layer type electrochemical system has such a problem that a working electrode receives a thin solution placed thereon, while not being isolated but open, therefore allowing reactants to diffuse in from the sides or out to the sides. Furthermore, the conventional technology introduces a hydrophilic polyelectrolyte gel, which serves as a salt bridge in the chip, and in this case, most existing polyelectrolyte gels have a problem in that in organic solvents with low polarity, ions cannot be dissociated by the solvent, but form ion pairs within the polymer, so that the gels collapse not to be maintained at its original state.

The present disclosure is to present an electrochemical system and an electrochemical analysis method using the same which solve the lateral diffusion problem in the existing thin layer type electrochemical system by introducing a polyelectrolyte gel as a salt bridge, making them universally usable in the field of determining the number of electrons transferred n, and which invent a hydrophobic polyelectrolyte gel, making them applicable even to organic solvents.

### DISCLOSURE

### Technical Problem

The technical object to be achieved by the present disclosure is to provide a thin layer type electrochemical system including a salt bridge and an electrochemical analysis method using the same, which can implement a thin chamber part, use a specific polyelectrolyte gel, derive the number of electrons transferred n quickly and accurately, be applicable not only to aqueous solvents but also to organic solvents, and measure electrochemical signals and spectroscopic changes simultaneously using a transparent working electrode.

However, the objects to be achieved by the present disclosure are not limited to the above-mentioned one, and other unmentioned objects will be clearly understood by those skilled in the art from the following description.

### Technical Solution

An embodiment of the present disclosure provides a thin layer type electrochemical system including a salt bridge, which is an electrochemical system for electrochemical reaction analysis, the thin layer type electrochemical system including a salt bridge including: a chamber part which accommodates an analysis solution and is provided with a working electrode on its one side; a channel part which accommodates an electrolyte solution; and one or more salt bridge parts which include a polyelectrolyte gel and are formed between the chamber part with the channel part, wherein each of the channel part and the chamber part includes one or more holes communicating with the outside, and wherein the chamber part is isolated by the salt bridge part which include a polyelectrolyte gel.

According to an embodiment of the present disclosure, the analysis solution may be a hydrophilic solution or a hydrophobic solution.

According to an embodiment of the present disclosure, the thickness of the chamber part may be 5 (m or greater and less than 50 μm.

According to an embodiment of the present disclosure, the polyelectrolyte gel included in the salt bridge part may be selected from the group consisting of poly diallyldimethylammonium chloride (pDADMAC), poly laurylacrylate tetrakis(3,5-bis(trifluoromethyl)phenyl)borate (PLA-TFPB) and a combination thereof.

According to an embodiment of the present disclosure, when the analysis solution a is hydrophilic solution, the polyelectrolyte gel may be poly diallyldimethylammonium chloride.

According to an embodiment of the present disclosure, when the analysis solution is a hydrophobic solution, the polyelectrolyte gel may be poly laurylacrylate tetrakis(3,5-bis(trifluoromethyl)phenyl)borate.

According to an embodiment of the present disclosure, the working electrode may be an electrode selected from the group consisting of gold, platinum, carbon, indium tin oxide (ITO), and semiconducting materials.

According to an embodiment of the present disclosure, the hole of the channel part may include a reference electrode hole provided with a reference electrode and a counter electrode hole provided with a counter electrode.

According to an embodiment of the present disclosure, the hole of the chamber part may include an inlet hole for injecting the analysis solution and a outlet hole for removing the analysis solution.

According to an embodiment of the present disclosure, the volume of the chamber part may be 0.1 μl or greater and 5.0 μl or less.

According to an embodiment of the present disclosure, the polyelectrolyte gel may be polymerized by irradiating light at the salt bridge part.

According to an embodiment of the present disclosure, when the working electrode is ITO, the system may further include a light irradiation part which irradiates light toward one side of the thin layer type electrochemical system including a salt bridge; and a light detection part provided to correspond to the light irradiation part and detect the irradiated light may be further included.

According to an embodiment of the present disclosure, the salt bridge part may separate the channel part and the chamber part from each other so that each of the electrolyte solution and the analysis solution does not flow between them.

An embodiment of the present disclosure provides an electrochemical analysis method for analyzing an electrochemical reaction using said thin layer type electrochemical system including a salt bridge, the electrochemical analysis method including injecting an analysis solution into the chamber part and injecting an electrolyte solution into the channel part; providing a reference electrode and a counter electrode in the channel part; and measuring an electrochemical signal from the working electrode.

According to an embodiment of the present disclosure, the method may further include calculating the number of electrons transferred from the measured electrochemical signal, and the analysis solution of a predetermined concentration may be injected.

According to an embodiment of the present disclosure, the electrochemical signal may be one selected from the group consisting of current, the amount of charge, potential difference, and combinations thereof.

According to an embodiment of the present disclosure, when the working electrode is ITO, the electrochemical signal may be measured while at the same time the spectroscopic change is measured with a light detection part.

According to an embodiment of the present disclosure, the volume of the analysis solution may be 0.1 μl or greater and 5.0 μl or less.

### Advantageous Effects

Unlike conventional thin layer type electrochemical cells, the thin layer type electrochemical system including a salt bridge, which is an embodiment of the present disclosure, can lead to mass production and high throughput because of manufacturing it in the form of a microchip using microfabrication technology, thereby enabling it to be highly accessible and easily industrialized, and can prevent the lateral diffusion, which was a problem in the existing thin layer electrochemistry. Through this, the salt bridge is formed around the working electrode, thereby allowing current caused by ions to flow but preventing physical diffusion, so that when performing constant voltage electrolysis, the added reactant can be 100% electrolyzed, thereby enabling the accurate measurement of the number of electrons transferred.

In the electrochemical analysis method, which is an embodiment of the present disclosure, all reactants are located within a thickness thinner than the diffusion layer, so the diffusion effect from the bulk can be ignored, and unlike in the existing voltammetric method in which the peak voltage is determined by the effects of both electron transfer speed and diffusion, only the electron transfer speed affects the peak voltage, so the peak occurs at a lower overvoltage, and the current falls more steeply after the peak, making it easier to distinguish between multiple consecutive peaks, and thus in estimating the mechanism, it is possible to intuitively predict how many electron transfer reactions are involved.

The effects of the present disclosure are not limited to the aforementioned ones, but other unmentioned effects thereof will be clearly understood by those skilled in the art from the present specification and the accompanying drawings.

### BRIEF DESCRIPTION OF DRAWINGS

FIG. 1 shows a photograph of a thin layer type electrochemical system including a salt bridge according to an embodiment of the present disclosure.

FIG. 2 shows plan and cross-sectional views of a thin layer type electrochemical system including a salt bridge according to an embodiment of the present disclosure.

FIG. 3 shows a schematic cross-sectional view of a thin layer type electrochemical system including a salt bridge according to an embodiment of the present disclosure.

FIG. 4 shows photographs of the salt bridge part of the thin layer type electrochemical system including a salt bridge according to an embodiment of the present disclosure, depending on the type of analysis solution when the salt bridge part includes a hydrophobic polyelectrolyte gel.

FIG. 5 shows a schematic diagram and photograph of a thin layer type electrochemical system including a salt bridge according to an embodiment of the present disclosure, and light irradiation and light detection parts for measuring spectroscopic changes.

FIG. 6 is a schematic diagram of a method for manufacturing a thin layer type electrochemical system including a salt bridge according to an embodiment of the present disclosure.

FIG. 7 shows graphs representing the change in the number of electrons transferred over time depending on whether or not the salt bridge part of the thin layer type electrochemical system including a salt bridge contains a polyelectrolyte gel.

FIG. 8 shows graphs representing the number of electrons transferred measured according to the voltage applied to a thin layer type electrochemical system including a salt bridge according to an embodiment of the present disclosure.

FIG. 9 shows graphs representing changes in voltage and current according to the reactions measured by a thin layer type electrochemical system including a salt bridge according to an embodiment of the present disclosure and a conventional technology, respectively.

FIG. 10 shows graphs representing absorbance according to wavelength as measured by an electrochemical system including a light irradiation part and a light measurement part for measuring spectroscopic changes.

FIG. 11 shows graphs representing changes in voltage and current according to the thickness of the chamber part of the thin layer type electrochemical system including a salt bridge.

### MODE FOR INVENTION

Throughout this specification, when a part “includes” or “comprises” a component, it means not that the part excludes other component, but instead that the part may further include other component unless expressly stated to the contrary.

Throughout the specification of the present application, when a member is described as being located “on” another member, this includes not only a case in which the member is in contact with the other member but also a case in which another member exists between the two members.

Hereinafter, the present disclosure will be described in more detail.

An embodiment of the present disclosure provides a thin layer type electrochemical system including a salt bridge, which is an electrochemical system for electrochemical reaction analysis, the thin layer type electrochemical system including a salt bridge including: a chamber part which accommodates an analysis solution and is provided with a working electrode on its one side; a channel part which accommodates an electrolyte solution; and one or more salt bridge parts which include a polyelectrolyte gel and are formed between the chamber part with the channel part, wherein each of the channel part and the chamber part includes one or more holes communicating with the outside, and wherein the chamber part is isolated by the salt bridge part which include a polyelectrolyte gel.

Unlike conventional thin layer type electrochemical cells, the thin layer type electrochemical system including a salt bridge, which is an embodiment of the present disclosure, can lead to mass production and high throughput because of manufacturing it in the form of a microchip using microfabrication technology, thereby enabling it to be highly accessible and easily industrialized, and can prevent the lateral diffusion, which was a problem in the existing thin layer electrochemistry. Through this, the salt bridge is formed around the working electrode, thereby allowing current caused by ions to flow but preventing physical diffusion, so that when performing constant voltage electrolysis, the added reactant can be 100% electrolyzed, thereby enabling the accurate measurement of the number of electrons transferred.

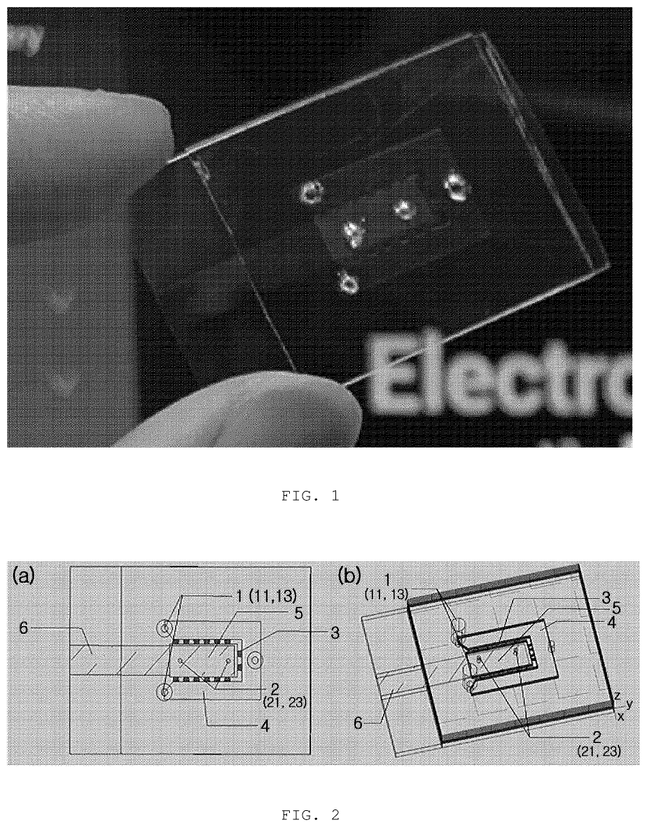

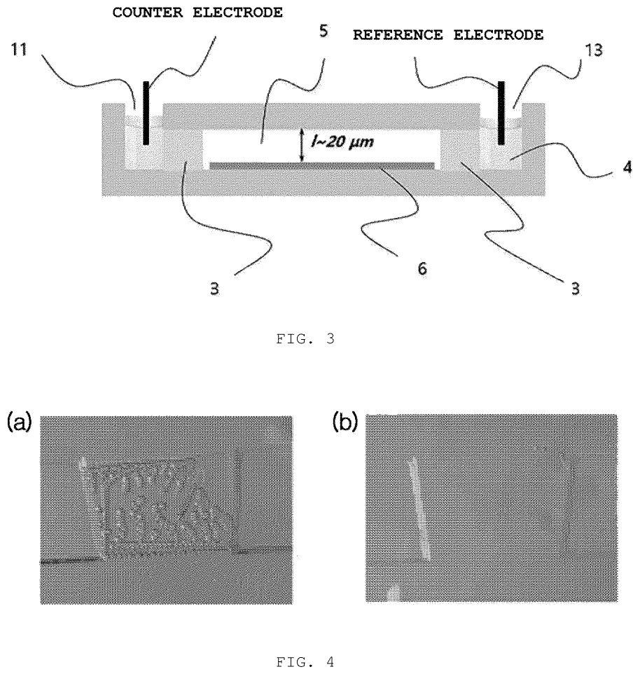

FIG. 1 shows a photograph of a thin layer type electrochemical system 100 including a salt bridge according to an embodiment of the present disclosure. FIG. 2 shows plan and cross-sectional views of a thin layer type electrochemical system 100 including a salt bridge according to an embodiment of the present disclosure. FIG. 3 shows a schematic cross-sectional view of a thin layer type electrochemical system 100 including a salt bridge according to an embodiment of the present disclosure.

With reference to FIGS. 1 to 3, a thin layer type electrochemical system including a salt bridge will be described in detail.

According to an embodiment of the present disclosure, the thin layer type electrochemical system 100 including a salt bridge includes a chamber part 5 which accommodates an analysis solution and is provided with a working electrode 6 on its one side. Specifically, the chamber part 5 includes the analysis solution so that the analysis solution is provided therein, and one surface of the chamber part 5 is provided with the working electrode 6. As described above, by the chamber part 5 accommodating the analysis solution, it is possible to block the analysis solution from flowing into the channel part 4 and prevent its lateral diffusion as will be described later, thereby enabling the electrolysis of a known amount of analyte, so that the number of electrons transferred can be measured accurately and quickly.

According to an embodiment of the present disclosure, the working electrode 6 may be provided on part or all of one surface of the chamber part 5. Specifically, the working electrode 6 may be provided by being deposited on part or all of one surface of the chamber part 5. As described above, by providing the working electrode 6 on part or all of one surface of the chamber part 5, it is possible to improve the reaction area with the reaction solution, and to measure electrochemical signals quickly.

According to an embodiment of the present disclosure, the working electrode 6 may be exposed to the outside. As will be specifically described later, the thin layer type electrochemical system including a salt bridge may be formed by coupling an upper substrate and a lower substrate to each other, and at least one of the upper substrate and the lower substrate may be extended farther outward to be exposed to the outside with the working electrode 6 deposited on that extended substrate to be exposed to the outside. Alternatively, the upper substrate may be cut to a shorter length to allow the working electrode deposited on the lower substrate to be exposed, and then the upper substrate may be coupled to the lower substrate. As described above, by forming the working electrode 6 to be exposed to the outside, an electrochemical circuit can be easily formed through the connection of the working electrode 6.

According to an embodiment of the present disclosure, the thin layer type electrochemical system including a salt bridge includes the channel part 4 which accommodates an electrolyte solution. Specifically, by the channel part 4 accommodating the electrolyte solution, an electrochemical circuit can be formed through the connection of a reference electrode and a counter electrode to be provided in the channel part 4, as will be described later. Furthermore, as the channel part 4 is disconnected from the chamber part 5 to prevent the reaction solution in the chamber part 5 from diffusing into the channel part 4, it is possible to improve the accuracy of the electrochemical signal.

According to an embodiment of the present disclosure, the thin layer type electrochemical system including a salt bridge includes one or more salt bridge parts 3 which include a polyelectrolyte gel and are formed between the chamber part 5 with the channel part 4. Specifically, the salt bridge part 3 may be formed to connect and communicate the chamber part 5 with the channel part 4, and the polyelectrolyte gel contained in the salt bridge part 3 may be provided between the chamber part 5 and the channel part 4. As described above, by using one or more salt bridge parts 3 including the polyelectrolyte gel and formed between the chamber part 5 with the channel part 4, and by isolating the channel part 4 and the chamber part 5 from each other to prevent the lateral diffusion from affecting the signal measured at the working electrode, and at the same time, to prevent the reaction solution in the chamber part 5 from reacting with and affecting the counter electrode, the accuracy of the electrochemical signal can be improved.

According to an embodiment of the present disclosure, the chamber part is isolated by the polyelectrolyte gel. Specifically, as the chamber part is disconnected or physically isolated from the outside to prevent the lateral diffusion, such as preventing the reaction solution from moving to the outside or the material in the channel part from moving into the chamber part, it is possible to improve the accuracy of the measured electrochemical signal. According to an embodiment of the present disclosure, the salt bridge part 3 can physically isolate the chamber part 5 and the channel part 4 from each other with the polyelectrolyte gel. Specifically, as the salt bridge part 3 is provided with the polyelectrolyte gel and the polyelectrolyte gel blocks the electrolyte solution and the analysis solution from passing through the salt bridge part, it is possible to improve the accuracy of the electrochemical signal. According to an embodiment of the present disclosure, the channel part 4 includes one or more holes 1 communicating with the outside. Specifically, the channel part 4 includes a hole 1 to be connected to and communicate with the outside of the thin layer type electrochemical system including a salt bridge. Specifically, the channel part 4 may include a hole 1 for injecting or removing the electrolyte solution into or from the channel part 4, and may include a hole 1 that can be provided with the reference electrode or the counter electrode to measure the electrochemical signal. The hole for injecting or removing the electrolyte solution and the hole provided with the reference electrode or counter electrode may be the same hole or may be separately formed holes. As described above, the channel part 4 includes one or more holes 1 in communication with the outside, so that it may be provided with the reference electrode and/or the counter electrode to form an electrochemical circuit through the electrical connection of the reference electrode or the counter electrode for measuring an electrochemical signal, or so that an electrolyte solution may be injected into or removed from the channel part.

According to an embodiment of the present disclosure, the chamber part 5 includes one or more holes 2 communicating with the outside. Specifically, the chamber part 5 includes a hole 2 to be connected to and communicate with the outside of the thin layer type electrochemical system including a salt bridge. Specifically, the chamber part 5 may include a hole 2 for injecting or removing the analysis solution into or from the chamber part 5. The hole 21 for injecting the analysis solution and the hole 23 for removing the analysis solution may be the same hole or may be separately formed holes. As described above, the chamber part 5 includes one or more holes 2 communicating with the outside, so that the analysis solution, which is a solution for analysis, may be injected into or removed from the chamber part 5 to measure an electrochemical signal.

According to an embodiment of the present disclosure, the analysis solution may be a hydrophilic solution or a hydrophobic solution. Specifically, the analysis solution may be an organic solution containing an organic solvent or an aqueous solution containing an aqueous solvent. In this specification, an organic solution may refer to a solution containing an excessive amount of the organic solvent to have hydrophobicity. In this specification, the aqueous solution may refer to a solution containing an excessive amount of the aqueous solvent to have hydrophilicity. Specifically, even if the analysis solution is a hydrophilic solution or a hydrophobic solution, the gel shape can be maintained by adjusting the components of the polyelectrolyte gel, thereby maintaining the isolation of the chamber part to prevent the lateral diffusion.

According to an embodiment of the present disclosure, the thickness of the chamber part 5 may be 5 μm or greater and less than 50 μm. Specifically, there is no particular limitation on the three-dimensional shape of the chamber part 5 as long as it can accommodate the analysis solution, and examples thereof may include a cube, polyhedron, or cylinder. The thickness of the chamber part 5 may refer to the thickness of its thickest portion from one side of the chamber part 5 on which the working electrode 6 is provided, and the thickness of the chamber part 5 may be 5 mm or greater and less than 50 μm. By adjusting the thickness of the chamber part 5 within the above-mentioned range, the number of electrons transferred can be easily obtained due to exclusion of semi-infinite diffusion, and the reactants contained in the reaction solution react quickly and are depleted, thereby enabling the realization of high resolution of the voltammetric peak.

According to an embodiment of the present disclosure, the polyelectrolyte gel included in the salt bridge part 3 may be selected from the group consisting of poly diallyldimethylammonium chloride (pDADMAC), poly laurylacrylate tetrakis(3,5-bis(trifluoromethyl)phenyl)borate (pLA-TFPB) and a combination thereof. By using a polyelectrolyte gel selected from the above-described ones, a hydrophilic polyelectrolyte gel and a hydrophobic polyelectrolyte gel can be selected, and by thus adjusting the properties of the polyelectrolyte gel, electrochemical signals can be measured even if the analysis solution is an organic solution or an aqueous solution.

According to an embodiment of the present disclosure, when the analysis solution is a hydrophilic solution, the polyelectrolyte gel may be poly diallyldimethylammonium chloride. As described above, when the analysis solution is hydrophilic, the poly diallyldimethylammonium chloride is selected as the polyelectrolyte gel, thereby enabling the channel part and the chamber part to be physically isolated by the polyelectrolyte gel, so that it is possible to measure an accurate electrochemical signal.

According to an embodiment of the present disclosure, when the analysis solution is a hydrophobic solution, the polyelectrolyte gel may be poly laurylacrylate tetrakis(3,5-bis(trifluoromethyl)phenyl)borate. As described above, when the analysis solution is a hydrophobic solution, poly laurylacrylate tetrakis(3,5-bis(trifluoromethyl)phenyl)borate is selected as the polyelectrolyte gel, so that it is possible to prevent such a problem that in an organic solvent with low polarity due to the hydrophilic nature of the polymer, ions cannot be dissociated by the solvent, but form ion pairs within the polymer, causing the polymer to collapse and not to maintain the gel state.

According to an embodiment of the present disclosure, the working electrode 6 may be an electrode selected from the group consisting of gold, platinum, carbon, indium tin oxide (ITO), and semiconducting materials. Specifically, the working electrode 6 is preferably made of indium tin oxide (ITO). By selecting the material of the working electrode 6 from the above-described ones, it is easy to manufacture in the form of a chip, the influence of background current can be reduced, and spectroscopic signals can also be measured due to transparency.

According to an embodiment of the present disclosure, the thin layer type electrochemical system including a salt bridge can be manufactured on a substrate made of any material including, but not limited to, glass, quartz, or silicon. In addition, poly (dimethylsiloxane) (PDMS), poly (methyl methacrylate) (PMMA), polycarbonate (PC), polystyrene, cellulose acetate, poly(ethylene terephthalate (PETP), and the like can be used, and any polymer with which a channel or chamber can be formed by a known method such as nano lithography can be used without limitation. Additionally, the upper and lower substrates may be manufactured in the form of a joint body of two or three different materials by selecting different materials for them.

According to an embodiment of the present disclosure, the hole 1 of the channel part may include electrode holes 1 which are provided with the reference electrode and the counter electrode, respectively. Specifically, the electrode holes 1 of the channel part 4 may be provided by being formed respectively such that the reference electrode and the counter electrode are spaced apart from each other and exposed to the inside of the channel part 4. Additionally, the electrode holes 1 of the channel part 4 may be used simultaneously for injecting or removing an electrolyte solution. As described above, with the hole 1 of the channel part including the electrode holes 1 provided with the reference electrode and the counter electrode, respectively, the electrolyte solution can be injected into or removed from the channel part, and electrochemical signals can be measured by providing the counter electrode or the reference electrode and the counter electrode to the electrode holes 1 such that they are spaced apart from each other, and the analysis solution injected into the chamber part can be prevented from diffusing into the channel part, thereby enabling the accurate measurement of the electrochemical signals.

According to an embodiment of the present disclosure, the hole 1 of the channel part may include a reference electrode hole 11 provided with a reference electrode and a counter electrode hole 13 provided with a counter electrode. Specifically, the reference electrode hole 11 and the counter electrode hole 13 of the channel part 4 may be provided by being formed respectively such that the reference electrode and the counter electrode are spaced apart from each other and exposed to the inside of the channel part 4. Additionally, the reference electrode hole 11 and the counter electrode hole 13 of the channel part 4 may be used simultaneously for injecting or removing an electrolyte solution. As described above, with the hole of the channel part 4 including the reference electrode hole 11 provided with the reference electrode and the counter electrode hole 13 provided with the counter electrode, the electrolyte solution can be injected into or removed from the channel part 4, and electrochemical signals can be measured by providing the counter electrode to the counter electrode hole 13 and the reference electrode to the reference electrode hole 11, and the analysis solution injected into the chamber part 5 can be prevented from diffusing into the channel part 4, thereby enabling the accurate measurement of the electrochemical signals.

According to an embodiment of the present disclosure, the hole 2 of the chamber part may include an inlet hole 21 for injecting the analysis solution and a outlet hole 23 for removing the analysis solution. Specifically, the inlet hole 21 and the outlet hole 23 are formed as one hole to enable both injection and removing of the analysis solution, and the inlet hole 21 and the outlet hole 23 may be formed separately. As described above, with the hole of the chamber part 5 including the inlet hole 21 for injecting the analysis solution and the outlet hole 23 for removing the analysis solution, the analysis solution within the chamber part 5 can be easily replaced.

According to an embodiment of the present disclosure, the volume of the chamber part 5 may be 0.1 μl or greater and 5 μl or less. By adjusting the volume of the chamber part 5 within the above-mentioned range, the number of electrons transferred can be easily obtained due to exclusion of semi-infinite diffusion, and the reactants contained in the reaction solution react quickly and are depleted, thereby enabling the realization of high resolution of the voltammetric peak.

According to an embodiment of the present disclosure, the polyelectrolyte gel may be polymerized by irradiating light at the salt bridge part. As described above, by polymerizing the polyelectrolyte gel by irradiating light at the salt bridge part, the polymerization can be easily carried out at the location in the salt bridge part where the polyelectrolyte gel is intended to be placed.

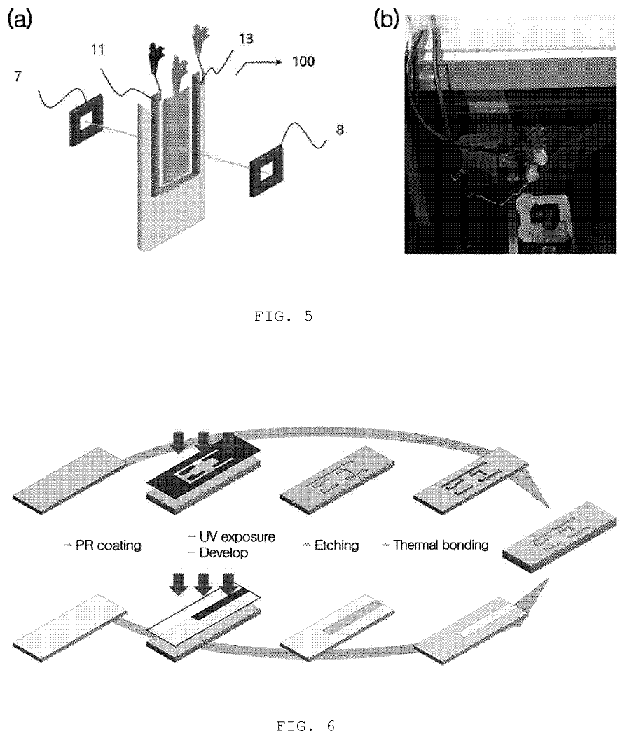

FIG. 4 shows photographs of the salt bridge part 3 of the thin layer type electrochemical system including a salt bridge according to an embodiment of the present disclosure, depending on the type of analysis solution when the salt bridge part includes a hydrophobic polyelectrolyte gel. Specifically, FIG. 4(a) shows a photograph of the salt bridge part 3 of the thin layer type electrochemical system including a salt bridge according to an embodiment of the present disclosure, when the analysis solution is an aqueous solvent and when the salt bridge part includes a hydrophobic polyelectrolyte gel; and FIG. 4(b) shows a photograph of the salt bridge part 3 of the thin layer type electrochemical system including a salt bridge according to an embodiment of the present disclosure, when the analysis solution is dichloromethane of the organic solvents and when the salt bridge part includes a hydrophobic polyelectrolyte gel. Referring to FIG. 4, the hydrophobic polyelectrolyte gel has a problem in that it is not maintained in a gel state by the analysis solution, which is the aqueous solvent. In contrast, it was confirmed that the hydrophobic polyelectrolyte gel was maintained in a gel state when the analysis solution was dichloromethane of the organic solvents, thereby isolating the chamber part 5 and the channel part 4 from each other.

FIG. 5 shows a schematic diagram and photograph of a thin layer type electrochemical system including a salt bridge according to an embodiment of the present disclosure, and light irradiation and light detection parts 7 and 8 for measuring spectroscopic changes. Referring to FIG. 5, according to an embodiment of the present disclosure, when the working electrode 6 is ITO, a light irradiation part 7 which irradiates light toward one side of the thin layer type electrochemical system including a salt bridge; and a light detection part 8 provided to correspond to the light irradiation part 7 and detect the irradiated light may be further included. Specifically, the working electrode 6 may be a transparent electrode, and the working electrode 6 is preferably ITO. Furthermore, when the working electrode 6 is a transparent electrode, the irradiated light is allowed to pass the working electrode, and the light absorbed by the reaction solution can be checked to determine the structure or reaction mechanism of the material produced during the reaction process. More specifically, a light irradiation part 7 which irradiates light toward the transparent electrode portion; and a light detection part 8 which detects the light outputted from the light irradiation part 7, passing through the chamber part 5 and irradiated to a position corresponding to the light irradiation part 7 may be included. As described above, when the working electrode 6 is ITO, a light irradiation part 7 which irradiates light toward one side of the thin layer type electrochemical system including a salt bridge; and a light detection part 8 provided to correspond to the light irradiation part 7 and detect the irradiated light may be further included, so that it is possible to perform electrochemical and spectroscopic measurements simultaneously, thereby enabling the prediction of changes in molecular structure.

According to an embodiment of the present disclosure, the salt bridge part may separate the channel part and the chamber part from each other so that each of the electrolyte solution and the analysis solution does not flow between them. Specifically, as the salt bridge part 3 is provided with the polyelectrolyte gel and the polyelectrolyte gel blocks the electrolyte solution and the analysis solution from passing through the salt bridge part, it is possible to improve the accuracy of the electrochemical signal.

FIG. 6 is a schematic diagram of a method for manufacturing a thin layer type electrochemical system including a salt bridge according to an embodiment of the present disclosure. Referring to FIG. 6, an embodiment of the present disclosure provides a method for manufacturing a thin layer type electrochemical system including a salt bridge, the method including preparing a lower substrate provided with the working electrode 6; preparing an upper substrate including the chamber part 5, the channel part 4, and the salt bridge part 3; forming a hole in each of the chamber part 5 and the channel part 4; joining the lower substrate and the upper substrate so that the working electrode 6 and the chamber part 5 correspond to each other; and forming the polyelectrolyte gel in the salt bridge part 3 by injecting a polyelectrolyte mixture into the hole and photocuring it in the salt bridge part.

Unlike conventional thin layer type electrochemical cells, the method for manufacturing a thin layer type electrochemical system including a salt bridge according to an embodiment of the present disclosure can lead to mass production and high throughput because of manufacturing it in the form of a microchip using microfabrication technology, thereby enabling it to be highly accessible and easily industrialized.

According to an embodiment of the present disclosure, the method includes preparing a lower substrate provided with the working electrode. Specifically, the step of preparing the lower providing the working electrode 6 by substrate may include photolithography. That is, it may include preparing a lower substrate; coating metal on the lower substrate; cleaning and drying the lower substrate on which the metal has coated; coating photoresist on the dried lower substrate and then patterning it through ultraviolet exposure and development; and etching the patterned lower substrate. By preparing the lower substrate as described above, a thin layer type electrochemical system including a salt bridge can be easily manufactured.

According to an embodiment of the present disclosure, it includes preparing the upper substrate including the chamber part 5, the channel part 4, and the salt bridge part 3. Specifically, it may include cleaning and drying an upper substrate; coating photoresist on the dried lower substrate and then patterning it into the shapes of the chamber part 5, the channel part 4, and the salt bridge part 3 through ultraviolet exposure and development; and etching the patterned upper substrate. By preparing the upper substrate as described above, a thin layer type electrochemical system including a salt bridge can be easily manufactured.

According to an embodiment of the present disclosure, it includes forming the holes 1 and 2 in the chamber part 5 and the channel part 4, respectively. The holes 1 and 2 may be formed using a drill. By preparing the holes as described above, a thin layer type electrochemical system including a salt bridge can be easily manufactured.

According to an embodiment of the present disclosure, it includes joining the lower substrate and the upper substrate so that the working electrode 6 and the chamber part 5 correspond to each other. Specifically, the working electrode 6 may be included in or arranged to coincide with the position of the chamber part 5, and when the working electrode 6 is wider than the chamber part 5, the working electrode 6 may be arranged to include the chamber part 5 to join the lower substrate and the upper substrate to each other. By joining the lower substrate and the upper substrate as described above, the chamber part 5 and the channel part 4 can be sealed from the outside.

According to an embodiment of the present disclosure, it includes forming the polyelectrolyte gel in the salt bridge part 3 by injecting a polyelectrolyte mixture into the hole and photocuring it in the salt bridge part 3. Specifically, a polyelectrolyte mixture is injected through the formed hole as described later, and light such as ultraviolet radiation, visible light or the like is irradiated to the position where the salt bridge part 3 has been formed to photocure the polyelectrolyte mixture, so that the polyelectrolyte gel can be formed in the salt bridge part 3. By including the step of forming the polyelectrolyte gel as described above, the polyelectrolyte gel can be easily placed in the salt bridge part 3.

According to an embodiment of the present disclosure, the salt bridge part 3 can physically isolate the chamber part 5 and the channel part 4 from each other with the polyelectrolyte gel. Specifically, as the salt bridge part 3 is provided with the polyelectrolyte gel and the polyelectrolyte gel blocks the electrolyte solution and the analysis solution from passing through the salt bridge part, it is possible to improve the accuracy of the electrochemical signal.

According to an embodiment of the present disclosure, the hydrophilic polyelectrolyte gel may be formed by curing a hydrophilic polyelectrolyte mixture containing polymer monomers, dimers to decamers, or the like. In order to induce curing by light irradiation, the polymer monomer or polymer may be reacted using a material to which a photoinitiator is combined or by additionally adding a separate photoinitiator. Preferably, 2-acrylamido-2-methyl-1-propanesulfonic acid (AMPSA) or diallyldimethylammonium chloride (DADMAC) may be used as the polymer monomer, and 2-hydroxy-4′-(2-hydroxyethoxy)-2-methylpropiophenone, lithium phenyl-2, 4, 6-trimethylbenzoylphosphinate (LAP) and combinations thereof may be used as the photoinitiator, and, however, any material that can allow free entry and exit of electrolyte ions when cured to form a gel and can form a conductive polymer which can be cured by light irradiation may be used without limitation.

Further, a cross-linking agent may be additionally added to stabilize the structure of the prepared polyelectrolyte gel and form a more robust structure. As a manufacturing example, N,N′-methylenebisacrylamide may be used as the cross-linking agent, and, however, any material that can stabilize the prepared polyelectrolyte gel may be used without limitation.

According to an embodiment of the present disclosure, the hydrophobic polyelectrolyte gel may be a cured product of a polyelectrolyte mixture including an ionomer, an acrylate monomer, a cross-linking agent, and a photoinitiator. More specifically, it may be a reaction product according to Reaction formula 1 below.

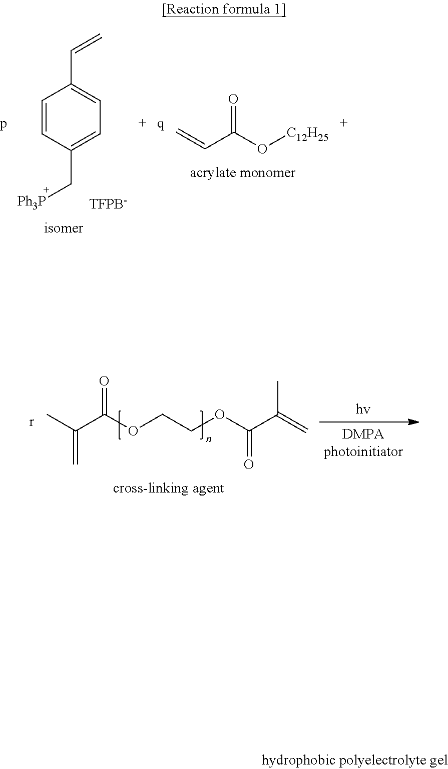

The DMPA is 2,2-Dimethoxy-2-phenylacetophenone.

In Reaction formula 1, the ratio p:q:r may be 3˜7:90˜99:0.5˜2. Preferably, the ratio p:q:r may be 5:95:1. By selecting the hydrophobic polyelectrolyte gel from the aforementioned ones, it is possible to prevent such a problem that in an organic solvent with low polarity due to the hydrophilic nature of the polymer, ions cannot be dissociated by the solvent, but form ion pairs within the polymer, causing the polymer to collapse and not to maintain the gel state.

One embodiment of the present disclosure provides a three-electrode system including a counter electrode provided in the counter electrode hole 13 and a reference electrode provided in the reference electrode hole 11 in the thin layer type electrochemical system including a salt bridge.

The three-electrode system, which is an embodiment of the present disclosure, can prevent the lateral diffusion, which was a problem in existing thin layer electrochemistry. Through this, the salt bridge part 3 is formed around the working electrode 6, thereby allowing current caused by ions to flow but preventing physical diffusion, so that when performing constant voltage electrolysis, the added reactant can be 100% electrolyzed, thereby enabling the measurement of accurate electrochemical signals.

An embodiment of the present disclosure provides an electrochemical analysis method for analyzing an electrochemical reaction using the thin layer type electrochemical system 100 including the salt bridge, the electrochemical analysis method including injecting an analysis solution into the chamber part 5 and injecting an electrolyte solution into the channel part 4; providing a reference electrode and a counter electrode in the channel part 4; and measuring an electrochemical signal from the working electrode.

In the electrochemical analysis method, which is an embodiment of the present disclosure, all reactants are located within a thickness thinner than the diffusion layer, so the diffusion effect from the bulk can be ignored, and unlike in the existing voltammetry in which the peak voltage is determined by the effects of both electron transfer speed and diffusion, only the electron transfer speed affects the peak voltage, so the peak occurs at a lower overvoltage, and the current falls more steeply after the peak, making it easier to distinguish between multiple consecutive peaks, and thus in estimating the mechanism, it is possible to intuitively predict how many electron transfer reactions are involved.

According to an embodiment of the present disclosure, it includes injecting an analysis solution into the chamber part 5 and injecting an electrolyte solution into the channel part 4. As described above, by including the step of injecting an analysis solution into the chamber part 5 and injecting an electrolyte solution into the channel part 4, electrochemical signals can be measured in the electrochemical system, and an electrochemical circuit can be constructed.

According to an embodiment of the present disclosure, it includes providing a reference electrode and a counter electrode in the channel part 4. As described above, by including the step of providing the reference electrode and the counter electrode in the channel part 4, an electrochemical signal can be measured with the counter electrode provided in the counter electrode hole 13 and the reference electrode provided in the reference electrode hole 11.

According to an embodiment of the present disclosure, it includes measuring an electrochemical signal from the working electrode 6. Specifically, a voltage, which is an electrochemical signal between the working electrode 6 and the reference electrode, may be measured, and a current, which is an electrochemical signal between the working electrode 6 and the counter electrode, may be measured. As described above, by measuring the electrochemical signal at the working electrode 6, the current can be measured according to the voltage using cyclic voltammetry or square wave voltammetry and the number of electrons transferred n.

According to an embodiment of the present disclosure, it further includes calculating the number of electrons transferred from the measured electrochemical signal, and the analysis solution of a predetermined concentration may be injected.

Specifically, it is determined from cyclic voltammetry which voltage band the electron transfer of the reaction of interest occurs at. A constant voltage is applied using the chronocoulometry technique to provide sufficient overvoltage for the above reaction to proceed. At this time, the amount of charge is measured over time. Afterwards, electrolysis is performed until the current drops to the background level (=until the amount of charge becomes constant), and through the constant charge Q⁰ at this time and the number of moles N (concentration*volume) of the inputted reactant, the number of electrons transferred n is obtained from Faraday's electrolysis law (Q⁰=nFN). As described above, by further including the step of calculating the number of electrons transferred from the measured electrochemical signal, and by injecting the analysis solution of a predetermined concentration, the number of electrons transferred can be easily calculated from the electrochemical signal measured for the analysis solution having a predetermined concentration.

According to an embodiment of the present disclosure, the electrochemical signal may be one selected from the group consisting of current, the amount of charge, potential difference, and combinations thereof. As described above, by measuring an electrochemical signal which is one selected from the group consisting of current, the amount of charge, potential difference, and combinations thereof, the current can be measured according to the voltage using cyclic voltammetry or square wave voltammetry and the number of electrons transferred n.

According to an embodiment of the present disclosure, when the working electrode is ITO, the electrochemical signal may be measured while at the same time the spectroscopic change is measured with the light detection part 8. As described above, when the working electrode is ITO, by measuring the electrochemical signal while at the same time the spectroscopic change is measured with the light detection part 8, changes in molecular structure can be predicted through these electrochemical and spectroscopic measurements possibly performed simultaneously.

According to an embodiment of the present disclosure, the volume of the analysis solution may be 0.1 μl or greater and 5.0 pl or less. As described above, by adjusting the volume of the analysis solution, the number of electrons transferred can be accurately measured, and the amount of time for measuring the number of electrons transferred can be minimized.

According to an embodiment of the present disclosure, a voltage-current graph can be derived by measuring the electrochemical signals. Specifically, cyclic voltammetry or square wave voltammetry is used to obtain current according to voltage. In this regard, the square wave voltammetry has higher sensitivity. And in order to clearly demonstrate the characteristics of thin-layer electrochemistry, a low voltage scan rate must be used.

### DESCRIPTION OF EMBODIMENTS

Hereinafter, the present disclosure will be described in detail with reference to examples. However, it should be noted that the examples according to the present disclosure may be modified into various other forms, and the scope of the present disclosure is not construed as being limited to the examples to be described below. The examples of the present specification are provided to more completely explain the present disclosure to those of ordinary skill in the art.

### Manufacture Example 1: Manufacture of Thin Layer Type Electrochemical System

A thin layer type electrochemical system in the form of a thin microchip was manufactured by photolithography as follows. A glass on which ITO was coated and which was subject to patterning to obtain the desired size of the working electrode 6 constituted the lower substrate, and a glass with the channel part 4, chamber part 5, and salt bridge part 3 formed thereon constituted the upper substrate. The lower substrate, which was the ITO-coated glass, was prepared by being washed with ethanol, acetone, and distilled water and being dried. After spin coating the photoresist (AZ4620), the photoresist was patterned through UV exposure and development, and after etching of the ITO, lift-off was performed with acetone. The glass, which was the upper substrate, was washed with piranha solution, etched to 20 μm with buffered oxide etchant (BOE) in the same process, an inlet hole was drilled, and lift-off was performed with piranha solution. The upper substrate and the lower substrate were boiled in ammonia water for one or more hours, and attached and bonded to each other at high temperature to manufacture a microchip-type thin layer type electrochemical system.

Afterwards, a polyelectrolyte gel was formed in the salt bridge part 3 through UV photocuring. In the case of a microchip-type thin layer type electrochemical system for an aqueous solution, a poly diallyldimethylammonium chloride (pDADMAC) salt bridge was formed, and In the case of a microchip-type thin layer type electrochemical system for an organic solvent, a poly laurylacrylate tetrakis(3,5-bis(trifluoromethyl)phenyl)borate (pLA-TFPB) was formed.

### Manufacture Example 2: Hydrophobic Polyelectrolyte Synthesis

An ionomer was synthesized in which, as in Reaction formula 1, a quaternary phenylphosphonium salt was attached to the styrene and tetrakis(3,5-bis(trifluoromethyl)phenyl)borate (TFPB) was introduced as an anion. For this purpose, 4-chloromethylstyrene and triphenylphosphine were refluxed in 1:1 equivalent ratio in an acetonitrile solvent at 60° C., and the reaction was performed for 24 hours and then purification was performed. An anion substitution reaction was performed while agitating the purified with product sodium tetrakis(3,5-bis(trifluoromethyl)phenyl)borate (NaTFPB) in a 1:1 equivalent ratio for 18 hours using methanol as a solvent. When the resultant product is purified, the ionomer of Reaction formula 1 is obtained. Afterwards, lauryl acrylate (LA), a backbone monomer, and poly ethylene glycol (dimethylacrylate), a cross-linking agent, were mixed with the ionomer in a ratio of 5:95:1. After adding 2,2-Dimethoxy-2-phenylacetophenone (DMPA) as a photoinitiator at twice the ratio of the cross-linking agent, the mixed polyelectrolyte mixture was injected into a microchip-type thin layer type electrochemical system, and then polymerization was achieved through exposure to UV light with an intensity of 17 mJ/cm² for 16 seconds by aligning a photomask.

### Experimental Example 1: Electrochemical Analysis

After injecting the reaction solution into the inlet hole in an amount that can completely fill the chamber part 5 and injecting the electrolyte solution into the reference electrode hole 11, a reference electrode was provided in the reference electrode hole 11, and a counter electrode was provided in the counter electrode hole 13, thereby forming an electrochemical circuit as a three-electrode system with the reference electrode and the counter electrode. Afterwards, the samples were analyzed by a method such as cyclic voltammetry, square wave voltammetry, and constant voltage methods of an electrochemical measuring instrument, and as a result, high-resolution peaks were obtained from the voltammetry, and the number of electrons transferred n could be measured in a few minutes using the constant voltage method. Additionally, it was confirmed that spectroelectrochemistry measurement was possible in combination with a spectroscopic method due to the transparency of the microchip of the working electrode.

### Experimental Example 2: Measurement of Changes in the Number of Electrons Transferred Depending on the Presence or Absence of a Salt Bridge

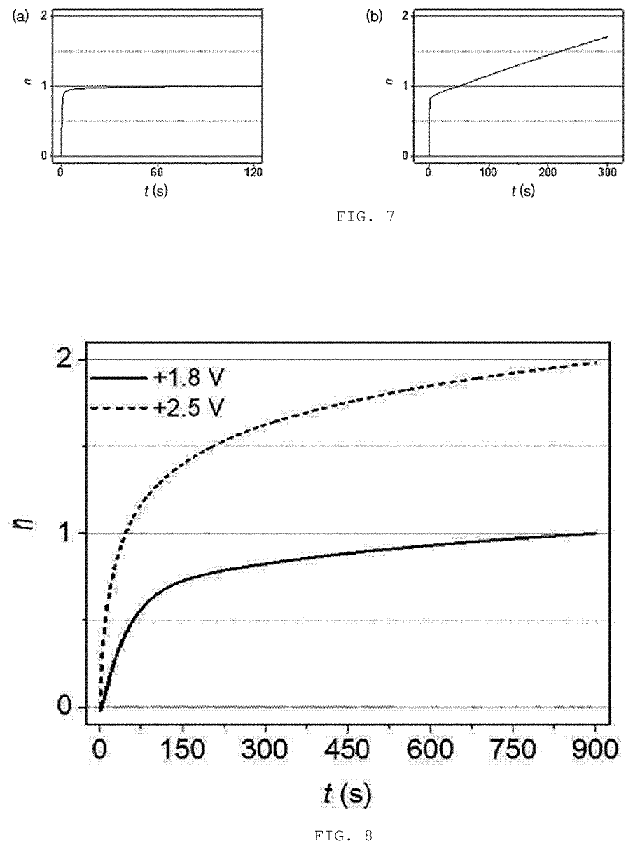

FIG. 7 shows graphs representing the change in the number of electrons transferred over time depending on whether or not the salt bridge part of the thin layer type electrochemical system including a salt bridge contains a polyelectrolyte gel. Specifically, by performing the reaction of Reaction formula 2 below in a thin-film electrochemical system including a salt bridge, the number of electrons transferred was measured.

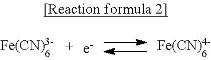

More specifically, it was performed under the condition of 1 mM ferrocyanide in 1M KCl aqueous solution. Referring to FIG. 7, FIG. 7(a) is a graph representing the change in the number of electrons transferred over time in a case where the salt bridge part of the thin layer type electrochemical system including a salt bridge contains a polyelectrolyte gel, and FIG. 7(b) is a graph representing the change in the number of electrons transferred over time in a case where the salt bridge part of the thin layer type electrochemical system including a salt bridge does not contain a polyelectrolyte gel. When the salt bridge part of the thin layer type electrochemical system including a salt bridge contained the polyelectrolyte gel, the plateau was reached within several tens seconds, and it was confirmed that the number of electrons transferred was 1.

In contrast, it was confirmed that when the salt bridge part of the thin layer type electrochemical system including a salt bridge did not contain the polyelectrolyte gel, the working electrode was not isolated and lateral diffusion occurred, resulting in a continuous increase in the amount of charge.

### Experimental Example 3

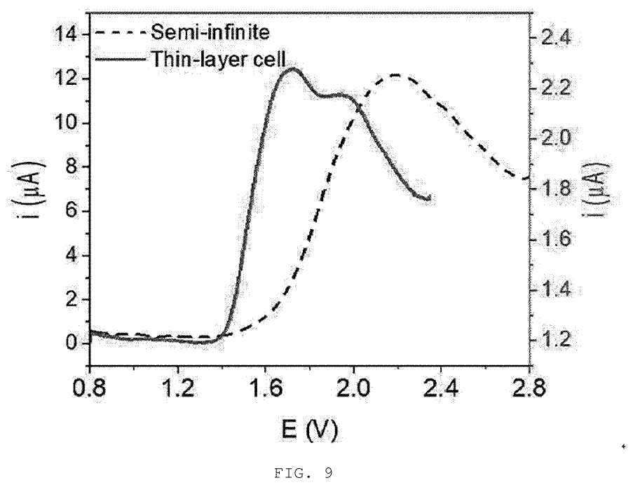

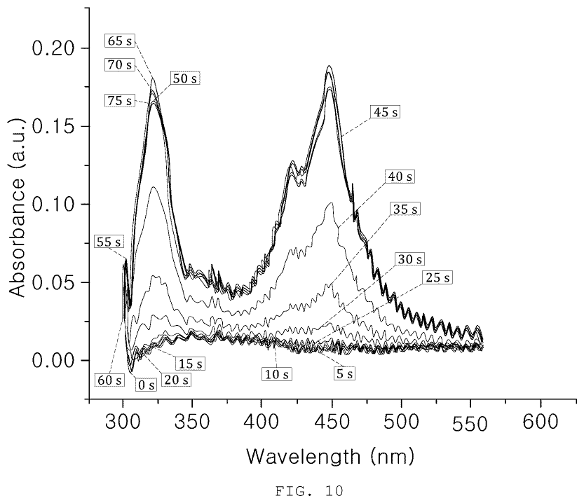

FIG. 8 shows graphs representing the number of electrons transferred measured according to the change in voltage applied to a thin layer type electrochemical system including a salt bridge according to an embodiment of the present disclosure. Specifically, the reaction was performed according to Reaction formula 3 below, and the number of electrons transferred n according to the solvent and applied voltage was measured.

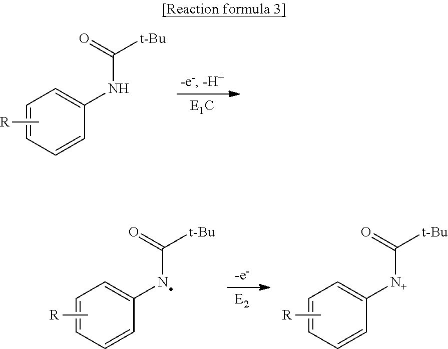

Referring to FIG. 8, it was confirmed that when 1.8 V was applied to N-(p-tolyl) pivalamide, the number of electrons transferred was 1, and when 2.5 V was applied, the number of electrons transferred was 2. Therefore, it can be analyzed that one-electron oxidation occurs in each step with Reaction formula 3 above.

### Experimental Example 4

FIG. 9 shows graphs representing changes in voltage and current according to the reactions measured by a thin layer type electrochemical system (thin-layercell) including a salt bridge according to an embodiment of the present disclosure and a conventional technology (semi-infinite), respectively. Specifically, the reaction according to Reaction formula 3 was performed, and changes in voltage and current were measured according to a thin layer type electrochemical system including a salt bridge according to an embodiment of the present disclosure, and changes in voltage and current were measured according to the conventional semi-infinite diffusion method.

Referring to FIG. 9, it was confirmed that compared to the prior art, the voltammetric peaks of two consecutive electron transfer reactions of the thin layer type electrochemical system including a salt bridge, which is an embodiment of the present disclosure, were clearly separated.

### Experimental Example 5

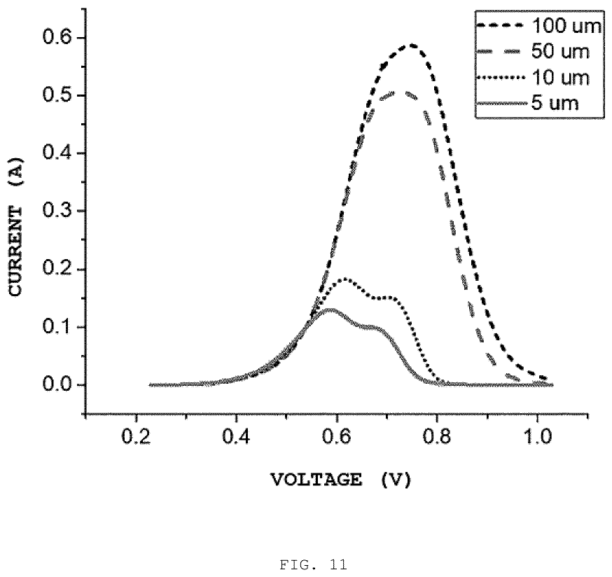

FIG. 10 shows graphs representing measurements of absorbance according to wavelength over time as measured by an electrochemical system including a light irradiation part and a light measurement part for measuring spectroscopic changes. Specifically, light was irradiated to a thin layer type electrochemical system including a salt bridge according to an embodiment of the present disclosure, and the absorbance of tetrachloroquinone, the reaction solution, was measured according to the wavelength.

Referring to FIG. 10, it was confirmed that the spectroscopic changes occurred in response to voltage and that the molecular structure change could be predicted through the specified absorbance.

### Experimental Example 6

FIG. 11 shows graphs representing changes in voltage and current according to the thickness of the chamber part of the thin layer type electrochemical system including a salt bridge. Specifically, these graphs represent measurements of the changes in voltage and current by square wave voltammetry while changing the thickness of the chamber part to 5 μm, 10 μm, 50 μm and 100 μm under the same reaction and conditions.

Referring to FIG. 11, it was confirmed that for the same reaction and conditions, when the thickness of the chamber part was 50 μm or 100 μm, the voltammetric peak appeared as one peak, whereas when the thickness of the chamber part was 5 μm or 10 μm, the voltammetric peak was separated into two peaks, improving the resolution.

Accordingly, the thin layer type electrochemical system including a salt bridge and the electrochemical analysis method using the same, which are embodiments of the present disclosure, implement a thin layer chamber, use a specific polyelectrolyte gel, and use a transparent working electrode, thereby measuring the peaks of several consecutive reactions in voltammetry with high resolution, enabling analysis of organic solvents, and allowing electrochemical and spectroscopic measurements to be performed simultaneously.

While the present disclosure has been described by limited embodiments until now, the present disclosure is not limited by them, and various modifications can be made by those skilled in the art to which the present disclosure pertains without departing from the equivalent scope of the technical idea of the present disclosure and the claims to be provided below.

### LIST OF REFERENCE SIGNS

1: Hole in channel part 11: Reference electrode hole
13: Counter electrode hole 2: Hole in chamber part
21: Inlet hole 23: Outlet hole
3: Salt bridge part 4: Channel part
5: Chamber part 6: Working electrode
7: Light irradiation part 8: Light detection part
100: Thin layer type electrochemical system including a salt bridge

1. A thin layer type electrochemical system including a salt bridge, which is an electrochemical system for electrochemical reaction analysis, the thin layer type electrochemical system including a salt bridge comprising:
a chamber part which accommodates an analysis solution and is provided with a working electrode on its one side;
a channel part which accommodates an electrolyte solution; and
one or more salt bridge parts which include a polyelectrolyte gel and are formed between the chamber part with the channel part,
wherein each of the channel part and the chamber part includes one or more holes communicating with the outside, and
wherein the chamber part is isolated by the salt bridge part which include a polyelectrolyte gel.

2. The thin layer type electrochemical system including a salt bridge of claim 1, wherein the analysis solution is a hydrophilic solution or a hydrophobic solution.

3. The thin layer type electrochemical system including a salt bridge of claim 1, wherein the thickness of the chamber part is 5 μm or greater and less than 50 μm.

4. The thin layer type electrochemical system including a salt bridge of claim 1, wherein the polyelectrolyte gel included in the salt bridge part is selected from the group consisting of poly diallyldimethylammonium chloride (pDADMAC), poly laurylacrylate tetrakis(3,5-bis(trifluoromethyl)phenyl)borate (pLA-TFPB) and a combination thereof.

5. The thin layer type electrochemical system including a salt bridge of claim 4, wherein when the analysis solution is a hydrophilic solution, the polyelectrolyte gel is poly diallyldimethylammonium chloride, and
wherein when the analysis solution is a hydrophobic solution, the polyelectrolyte gel is poly laurylacrylate tetrakis(3,5-bis(trifluoromethyl)phenyl)borate.

6. The thin layer type electrochemical system including a salt bridge of claim 1, wherein the working electrode is an electrode selected from the group consisting of gold, platinum, carbon, indium tin oxide (ITO), and semiconducting materials.

7. The thin layer type electrochemical system including a salt bridge of claim 1, wherein the hole of the channel part includes a reference electrode hole provided with a reference electrode and a counter electrode hole provided with a counter electrode.

8. The thin layer type electrochemical system including a salt bridge of claim 1, wherein the hole of the chamber part includes an inlet hole for injecting an analysis solution and a outlet hole for removing an analysis solution.

9. The thin layer type electrochemical system including a salt bridge of claim 1, wherein the volume of the chamber part is 0.1 μl or greater and 5.0 μl or less.

10. The thin layer type electrochemical system including a salt bridge of claim 1, wherein the polyelectrolyte gel is polymerized by irradiating light at the salt bridge part.

11. The thin layer type electrochemical system including a salt bridge of claim 6, wherein when the working electrode is ITO, the system further includes:
a light irradiation part which irradiates light toward one side of the thin layer type electrochemical system including a salt bridge; and
a light detection part provided to correspond to the light irradiation part and detect the irradiated light.

12. The thin layer type electrochemical system including a salt bridge of claim 1, wherein the salt bridge part separates the channel part and the chamber part from each other so that each of the electrolyte solution and the analysis solution does not flow between the channel part and the chamber part.

13. An electrochemical analysis method for analyzing an electrochemical reaction using a thin layer type electrochemical system including a salt bridge of claim 1, the electrochemical analysis method comprising:
injecting an analysis solution into the chamber part and injecting an electrolyte solution into the channel part;
providing a reference electrode and a counter electrode in the channel part; and
measuring an electrochemical signal from the working electrode.

14. The electrochemical analysis method of claim 13, further comprising:
calculating the number of electron transferred from the measured electrochemical signal, wherein the analysis solution of a predetermined concentration is injected.

15. The electrochemical analysis method of claim 13, wherein the electrochemical signal is one selected from the group consisting of current, the amount of charge, potential difference, and combinations thereof.

16. The electrochemical analysis method of claim 13, wherein when the working electrode is ITO, the electrochemical signal is measured while at the same time the spectroscopic change is measured with a light detection part.

17. The electrochemical analysis method of claim 13, wherein the volume of the analysis solution is 0.1 μl or greater and 5.0 μl or less.
